(19) United States
(12) Patent Application Publication
(10) Pub. No.: US 2026/0081352 A1
(43) Pub. Date: Mar. 19, 2026

(54) ANTENNA

(71) Applicant: Telefonaktiebolaget LM Ericsson (publ), Stockholm (SE)

(72) Inventors: Jan Grävendieck, Rosenheim (DE); Susanne Küschner, Rosenheim (DE); Hubert Polster, Kirchheim b. München (DE); Peter Feistl, Aschau (DE)

(21) Appl. No.: 19/110,085

(22) PCT Filed: Oct. 25, 2022
(86) PCT No.: PCT/EP2022/079813

§ 371 Date: Mar. 9, 2025

(51) Int. Cl. H01Q 3/32; H01Q 1/24; H01Q 1/52; H01Q 19/10

(52) U.S. Cl. CPC H01Q 3/32; H01Q 1/246; H01Q 1/526; H01Q 19/10

(57) ABSTRACT

An antenna, in particular for a mobile communication cell site, has radiators, a reflector, a first layer, a second layer, a third layer, and at least one phase shifter with at least one delay line and a shifting device. The radiators are mounted at the front side of the first layer, and the reflector for the radiators is provided by one of the layers. The second layer comprises a cutout extending vertically through the second layer, the cutout being closed to the front by the first layer and to the rear by the third layer forming a cavity. The delay line is arranged within a vertical projection of the cavity, and the shifting device comprises a shifting portion arranged in the cavity covering the delay line at least partly.

### TECHNICAL FIELD

The invention relates to an antenna comprising a phase shifter.

### BACKGROUND

Antenna arrays for mobile communication make use of phase shifters to tilt the beam. Some radiofrequency applications need analog phase shifters having a shifting device that needs to be shifted mechanically in order to create the necessary phase shift for tilting the beam. For array antennas, multiple phase shifters are required to control the phase of the different radiators or group of radiators accordingly.

Further, the phase shifters have to be arranged close to the radiators so that linear phase shifters on layers have been developed to simplify the arrangement of the phase shifter assemblies between columns of radiators.

Such phase shifter assemblies are known, for example, from CN 113328217 A, U.S. Pat. Nos. 7,026,889 B2, 10,062,940, EP 3 879 628 A1 and EP 2 879 235 B1.

In the known solutions, however, the housing and shielding of phase shifters is realized in one or more separate parts. Mechanical tolerances of these parts influence the quality of the phase shifter greatly because the distance to the delay lines determines the concentration of electrical field in the dielectric material of the shifting device, which causes the phase shift.

### SUMMARY

It is therefore an object of the invention to provide an antenna with a cost efficient phase shifter having a high quality.

For this purpose, an antenna is provided, in particular for a mobile communication cell site. The antenna comprises a plurality of radiators, a reflector for the radiators, a first layer, a second layer, a third layer, and at least one phase shifter with at least one delay line and a shifting device. The first layer, the second layer and the third layer extend parallel to one another, the second layer being located between the first layer and the third layer. The radiators are mounted at the front side of the first layer to the first layer, and the reflector for the radiators is provided by the first layer, the second layer and/or the third layer. The second layer comprises a cutout extending vertically through the second layer, the cutout being closed to the front by the first layer and to the rear by the third layer forming a cavity. The delay line is arranged within a vertical projection of the cavity, and the shifting device comprises an actuation portion and a shifting portion, the shifting portion being arranged in the cavity covering the delay line at least partly and being movably with respect to the delay line in a direction of motion.

By providing a cavity enclosed by layers, e.g. in a sandwich structure, the electric field is concentrated in the cavity and the parts shielding the cavity are standard parts that can be manufactured with high precision. Thus, cost and complexity are reduced while the quality of the phase shifter is high. At the same time, as the layers are also used to support the radiators and provide the reflector, the phase shifter is integrated into the antenna further reducing space and costs.

In particular, the reflector is provided by the first layer only.

The shifting device may be movable in such a way that the length of the part of the delay line covered by the shifting portion of the shifting device varies during movement. The direction of motion may coincide with the longitudinal direction of the phase shifter assembly.

In an embodiment, the delay line is located in the cavity, at the first layer on the side of the first layer facing the cavity, or at the third layer on the side of the third layer facing the cavity, so that the electric field corresponding to the delay line is particularly concentrated in the cavity.

In order to further improve the performance of the phase shifter, the first layer, the second layer and the third layer may electrically shield the cavity.

In an embodiment, the first layer comprises a first substrate, the third layer comprises a third substrate and/or the second layer comprises a second substrate or a metal sheet. This way, the antenna is manufactured by cost efficient components without compromising quality.

For example, the substrates are PCBs. The sheet metal of the second layer may provide the reflector for the radiators.

In order to further improve performance, an insulating material, in particular a solder stop mask, may be provided between the first layer and the second layer and/or between the second layer and the third layer.

In an aspect, the first layer comprises a first substrate and distribution lines on the front surface of the first substrate, the distribution lines being connected to the radiators, further reducing costs by using the first layer for multiple functions.

The distribution lines may form a distribution network for the radiators.

For concentrating functions in the first layer, the first layer may comprise a ground plane, in particular on the rear surface of the first substrate, wherein the ground plane providing the reflector for the radiators and/or covering the cutout of the second layer vertically.

In an embodiment, the at least one delay line is located at the third layer, in particular wherein the third layer comprises a third substrate and the delay line is located on the front side of the third substrate. This way, the second layer may be kept free of signal carrying lines, simplifying the second layer.

For concentrating functions in the third layer, the third layer may comprise a third ground plane, in particular at the rear surface of the third substrate, the third ground plane covering the cutout of the second layer and/or the delay line vertically.

The third ground plane is in particular grounded and/or is the reflector for radiators. The third ground plane and delay line may form a microstrip transmission line.

In an embodiment, a slot is provided, the slot extending in the third layer, in particular in the third substrate, in the direction of motion as well as from the cavity vertically rearwards through the third layer, or the slot extending in the second layer, in particular in the second substrate or the metal sheet, from the cavity transversally, wherein the actuation portion of the shifting device extends from the shifting portion through the slot. The slot allows actuation of the shifting device from outside the cavity so that the cavity can be kept small.

In order to provide a further substrate for further functionality of the antenna, the second layer may comprise a second substrate, in particular a PCB, wherein the faces of the second substrate defining the cutout are provided with a grounded conductive wall, in particular a metallization, and/or wherein a plurality of grounded vias are provided in the second substrate, the plurality of vias are arranged around the cutout with a distance between adjacent vias smaller or equal than one eighth of the wavelength of the average frequency of the design frequency range of the radiators.

In an embodiment, with respect to the transverse direction, the shifting portion comprises a middle section and two outer sections, wherein the outer sections have a rear end extending further to the rear than the middle section, in particular wherein the rear ends of the outer sections have a curved contour. Thus, the shifting portion provides a defined contact surface, minimizing passive intermodulation effects.

For example, the middle section is located in front of the delay line and/or the outer sections contact the third layer or an insulating material transversally besides the delay lines, leading to a precisely adjustable phase shifting device.

In a further aspect, the antenna comprises an actuating mechanism, in particular located at the rear side of the third layer, wherein the actuating mechanism is mechanically connected to the actuation portion of the shifting device and designed such that it is able to move the shifting device in the direction of motion. This way, the large components providing mechanical actuation do not have to be arranged at the front surface, leading to a further reduced footprint on the front surface.

For a simple and robust actuation of the shifting device, the actuating mechanism may comprise an actuator, in particular an electric motor, and a driving structure movable linearly in the direction of motion by the actuator, wherein the driving structure is attached to the actuation portion of the shifting device.

In order to further improve phase shifting precision, the shifting portion is made of a dielectric material and/or comprises cutouts.

For a compact design, the delay lines may be located next to the slot with respect to the direction of motion.

In an embodiment, at least two delay lines are provided in the vertical projection of the cavity and the shifting device comprises two shifting portions, wherein the slot is located between the two delay lines with respect to the direction of motion. By combining the two delay lines to a common input, a differential phase shifter is provided.

The shifting portions may merge into one another and/or the actuation portion may be located centrally between shifting portions.

In order to further reduce the antenna in size, the antenna comprises a plurality of cavities and a plurality of phase shifters, wherein the radiators are arranged in columns parallel to the direction of motion, in particular wherein the cavities and shifting portions are located between the radiators of adjacent columns of the array antenna.

In an embodiment, the antenna comprises a plurality of cavities and a plurality of phase shifters, wherein the actuation portions of two, more than two or all of the shifting devices is attached to a single driving structure, in particular at the rear side of the third layer, the driving structure being movable linearly in the direction of motion by an actuator. This way, the number of components can be reduced.

### BRIEF DESCRIPTION OF THE DRAWINGS

Further features and advantages will be apparent from the following description as well as the accompanying drawings, to which reference is made. In the drawings:

FIG. 1 shows a two dimensional array antenna with multiple columns according to an embodiment of the invention in a schematic front view,

FIG. 2 shows an exploded view of an array of radiators of one column of an array antenna according to the invention similar to the one shown in FIG. 1,

FIG. 3 shows a cross-section of the antenna of FIG. 2,

FIGS. 4, 5 show enlarged detailed cross-sections of the antenna shown in FIG. 2 at two different positions in the longitudinal direction,

FIGS. 6, 7 show cross-sections corresponding to the cross-section of FIG. 4 of a second and third embodiment of an antenna according to the invention,

FIG. 8 shows a horizontal section through the second layer of the antenna according to FIG. 7, and

FIG. 9 shows a cross-section corresponding to that of FIG. 4 of a third embodiment of an antenna according to the invention.

### DETAILED DESCRIPTION

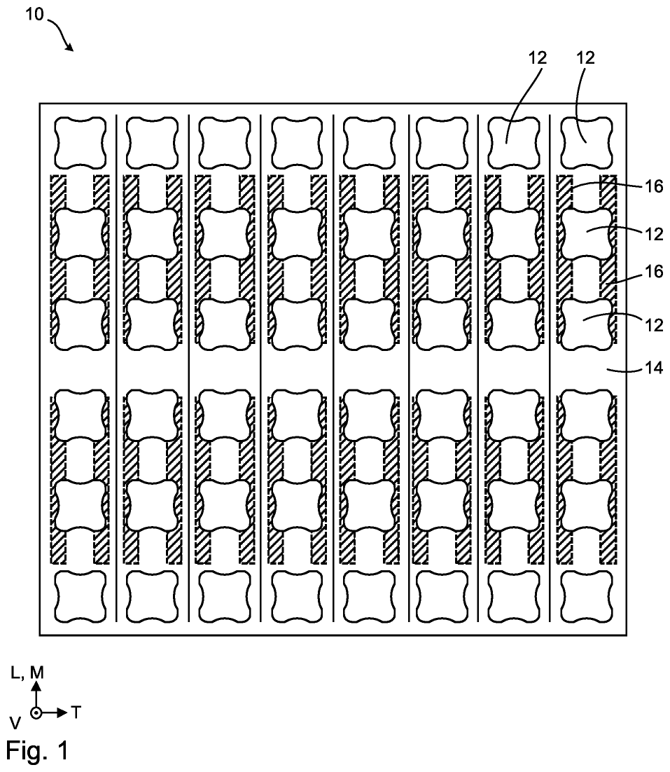

FIG. 1 shows an antenna 10 according to the invention in a front view.

The antenna 10 is, for example, an antenna for mobile communication, in particular for a mobile communication cell site. The antenna 10 may be configured to be used for radio frequency signals, for example having frequencies between 0.5 GHz and 5 GHz.

The antenna 10 is, in the shown embodiment, an array antenna and comprises a plurality of dual polarized radiators 12, a common reflector 14 for the radiators 12 as well as a plurality of phase shifters 16.

As the array antenna 10 is a linear dual-polarized antenna, for both of the orthogonal polarizations a separate phase shifter arrangement is required.

In the shown embodiment, the radiators 12 are grouped in eight columns, each column constituting an antenna array with six radiators 12.

Further, each column of the array antenna 10 comprises four phase shifters 16, wherein a group of three radiators 12 are associated with two of the phase shifters 16.

The antenna 10 shown in FIG. 1 comprises eight columns, every column forming a subarray of six longitudinally stacked radiators and being arranged side-by-side as known in the art.

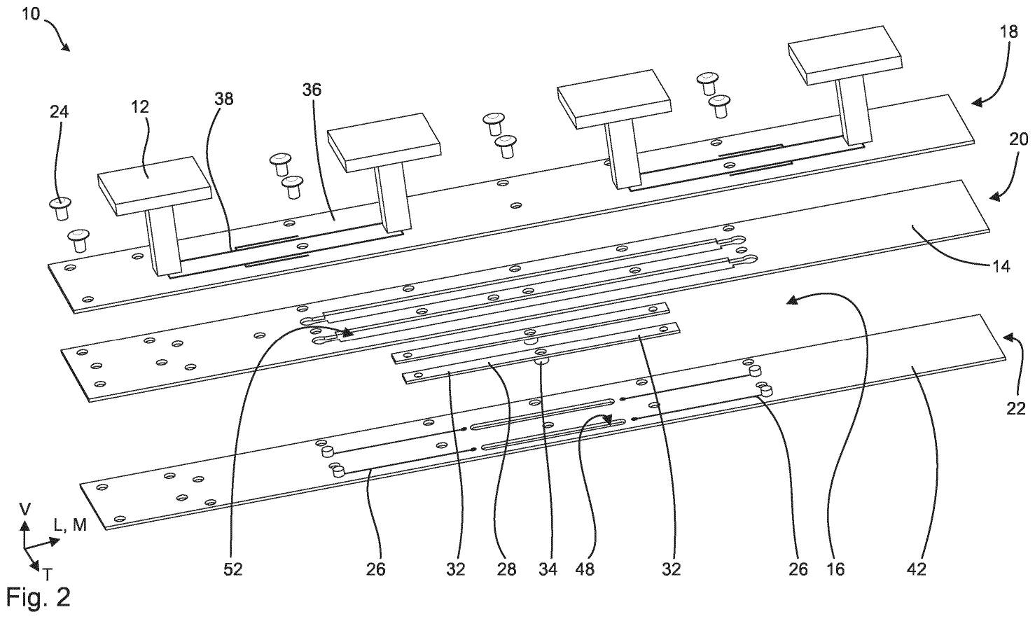

FIG. 2 shows an exploded view of an antenna 10 according to the invention similar to the one shown in FIG. 1. More precisely one group of four radiators 12 and two phase shifters 16 is shown. Every phase shifter 16 operates on the signals of one polarization. The two phase shifters are arranged in an isolated manner side by side.

The antenna 10 further comprises a first layer 18, a second layer 20, a third layer 22 as well as rivets 24.

Any numerals, like “first”, “second” and “third”, are only used for differentiation and do not imply a specific amount or order of components.

The antenna 10 has a vertical direction V, being the direction perpendicular to the surfaces of the layers 18, 20, 22 and corresponding substantially to the radiation direction when all radiators 12 emit electromagnetic radiation with the same phase.

Further, the antenna 10 has a longitudinal direction L and a transverse direction T are perpendicular to the vertical direction V. The longitudinal direction L corresponds to the direction of the column of radiators 12, and the transverse direction T is perpendicular to the longitudinal direction L.

The layers 18, 20, 22 extend in different planes spanning in the longitudinal direction L and in the transverse direction T. The layers 18, 20, 22 extend parallel to one another.

In the shown embodiment, the first layer 18 is located at the front, the second layer 20 is located in the middle, and the third layer 22 is located at the rear of the antenna 10.

The rivets 24 extend through all of the three layers 18, 20, 22 and attach the layers 18, 20, 22 together.

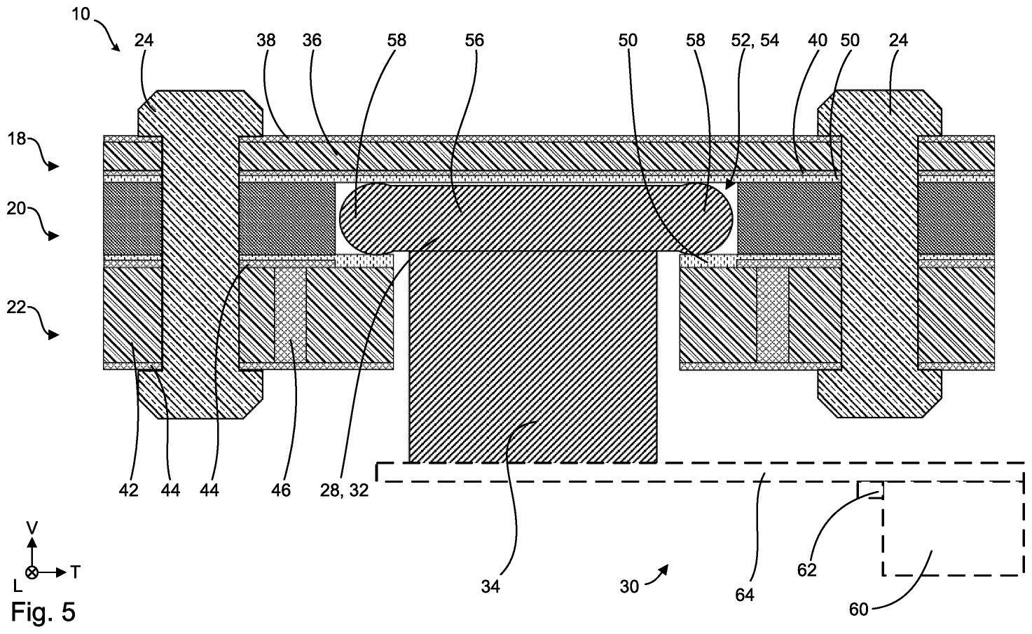

The phase shifters 16 comprises a delay line 26, a shifting device 28 and an actuating mechanism 30 (FIG. 5) for the shifting device 28.

In the shown embodiment, the delay lines 26 are located at the third layer 22 and coincide with one another in the longitudinal direction L.

The delay lines 26 extend in the longitudinal direction L, each between two ends.

One of the ends of each delay line 26 is associated with the radiator 12 and the other one of the ends is associated with the feeding.

In the shown embodiment, the ends associated with the feeding are the ends of the delay lines 26 facing towards each other, which might be regarded as inwards ends.

The ends associated with feeding of two delay lines 26 are connected to a common input forming a differential phase shifter.

The inwards ends are spaced apart in the longitudinal direction L, in particular by the length of a slot 48 in the third layer 22.

The ends associated with the radiators 12 are the ends of the delay lines 26 facing away from each other, which might be regarded as outwards ends.

The delay lines 26 extend between their ends in a straight line. It is also conceivable that the delay lines 26 have meanders between their ends or describe a single turn or U-shape. Any other shape is also conceivable.

The shifting device 28 comprises a shifting portion 32 and an actuation portion 34.

The shifting portion 32 is, for example, a pin extending vertically rearwards from the at least one shifting portion 32.

The shifting portion 32 is made of a dielectric material and it is conceivable that the shifting portion 32 and the actuation portion 34 are made integrally of a single piece of dielectric material.

The shifting device 28 is movable in a direction of motion M with respect to the delay lines 26, in particular with respect to the first, second and/or third layer 18, 20, 22.

The direction of motion M coincides with the longitudinal direction L and is also parallel to the layers 18, 20, 22.

In the shown embodiment, the phase shifters 16 are provided as differential phase shifters having two delay lines 26 connected to a common input and two shifting portions 32.

For example, both shifting portions 32 are made of a single piece.

The shifting portions 32 extend in opposite directions with respect to the longitudinal direction L. In the middle with respect to the longitudinal direction L, the two shifting portions 32 merge into one another and the actuation portion 34 extends from the shifting portions 32 rearwards.

Each of the shifting portions 32 is associated with one of the delay lines 26. The shifting portions 32 extend above the corresponding delay lines 26, i.e. at the front of the respective delay line 26.

Seen from the front, the shifting portion 32 thus covers at least parts of the delay line 26. The shifting portion 32 may consist of a dielectric material, which changes the resulting phase in the delay lines 26, when it is be moved along the delay line 26.

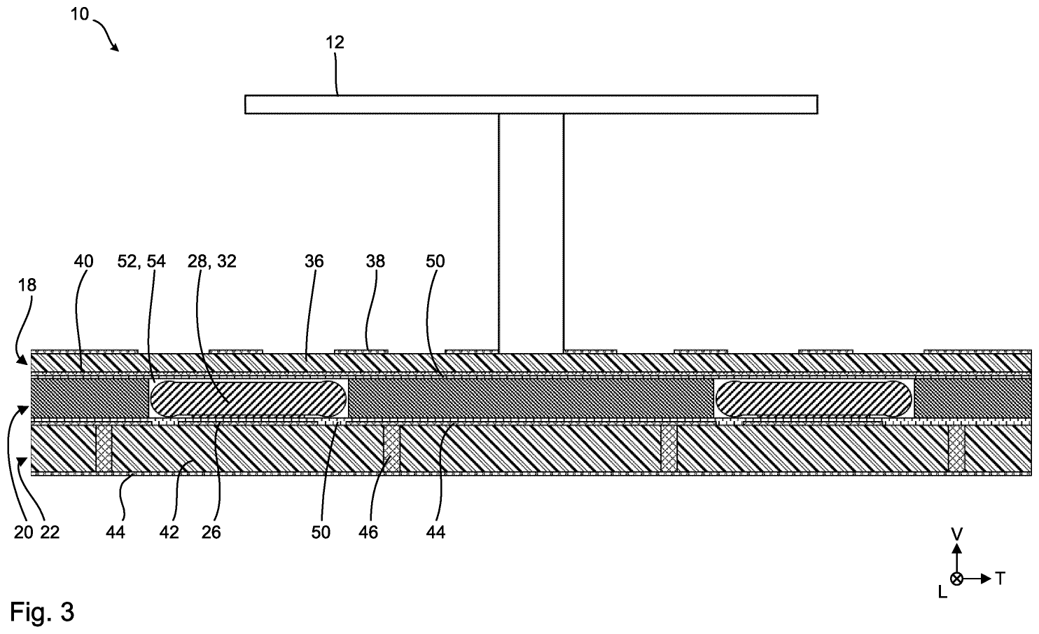

FIG. 3 shows a cross-section through the antenna 10 of FIG. 2.

In the shown embodiment, the first layer 18 comprises a first substrate 36, distribution lines 38 and a first ground plane 40. The first substrate 36 is, for example, a PCB.

The radiators 12 are located at the front of the first layer 18 and are attached to the front surface of the first substrate 36.

The distribution lines 38 are also located at the front surface of the first substrate 36. For example, the distribution lines 38 are metallizations applied to the front surface of the first substrate 36.

The distribution lines 38 are connected to the radiators 12 and the phase shifters 16, forming a distribution network. Every polarization of the radiators 12 requires a separate distribution network.

More precisely, the ends of the delay lines 26 associated with the radiators 12 are galvanically connected to the respective distribution line 38, in particular by a via extending through the second layer 20 and the first substrate 36.

On the rear surface of the first substrate 36, the first the ground plane 40 is provided.

The first ground plane 40 is grounded and may cover the entire rear surface of the first substrate 36. For example, the first ground plane 40 serves as the common reflector 14 of the radiators 12.

Further, the ground plane 40 is the ground plane for the distribution lines 38.

Rearward of the first layer 18, the phase shifters 16 are located partly enclosed by the second layer 20 and the third layer 22.

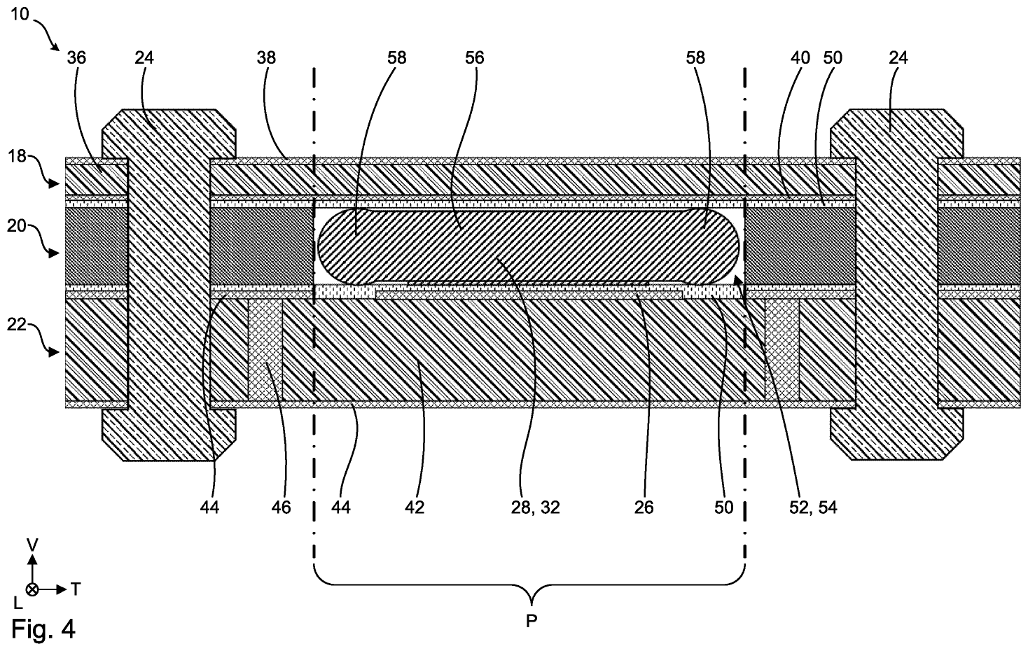

FIGS. 4 and 5 show a detailed cross-section through the layers 18, 20, 22 and parts of one of the phase shifters 16 in an enlarged view.

The third layer 22 comprises a third substrate 42, and two ground planes 44, called third ground planes 44 in the following.

The third substrate 42 extends in the transverse direction T and the longitudinal direction L. The third substrate 42 is, for example, a PCB.

One of the third ground planes 44 is located at the rear surface of the third substrate 42 and covers in particular the rear surface of the third substrate 42 fully.

The other third ground plane 44 may be located on parts of the front surface of the third substrate 42.

The third ground planes 44 are grounded and galvanically connected to one another by third vias 46 extending through the third substrate 42.

The third ground planes 44 made be reflectors 14 for the radiators 12 in some embodiments.

As best seen in FIG. 2, in the third layer 22, in particular in the third substrate 42, a slot 48 for each of the differential phase shifter 16 is located. To avoid repetition, the integration of only one of the differential phase shifters 16 in the layers 18, 20, 22 is discussed. The other differential phase shifters 16 are likewise integrated.

The slot 48 extends vertically through the third substrate 42 and in particular no third ground plane 44 is present vertically in front or at the rear of the slot 48.

The slot 48 extends in the longitudinal direction L of the third layer 22, i.e. the slot 48 is much longer in the longitudinal direction L than in the transverse direction T.

In the longitudinal direction L, the slot 48 is located between the two delay lines 26.

In the shown embodiment, the delay lines 26 extend at different sides of the slot 48 with respect to the longitudinal direction L and away from the slot 48, e.g. the inwards ends of the delay lines 26 are next to the slot 48.

In particular, the delay lines 26 are located at an imaginary extension of the slot 48 in the longitudinal direction L and next to the slot 48.

In the first embodiment, the second layer 20 is made of a sheet metal. In particular, the sheet metal is grounded, providing the reflector 14 for the radiators 12.

Insulating material 50, in particular a solder stop mask, may be provided between each of the layers 18, 20, 22, in particular between the first ground plane 40 of the first substrate 36 and the sheet metal of the second layer 20 as well as between the sheet metal of the second layer 20 and the third ground plane 44 on the front side of the third substrate 42.

The second layer 20 comprises a cutout 52 for each differential phase shifter 16, the cutout 52 being a cutout in the sheet metal in the shown embodiment.

The cutout 52 extends vertically through the entire second layer 20, i.e. the entire sheet metal.

The slot 48 is much larger in the longitudinal direction L than in the transverse direction T.

In the longitudinal direction L, the cutout 52 extends in front of the slot 48 of the third substrate 42 and in front of the delay lines 26.

In the transverse direction T, the cutout 52 may be wider than the slot 48.

At the front, the cutout 52 is closed by the first layer 18, in the shown embodiment by the first substrate 36, more precisely by the first ground plane 40 on the first substrate 36.

At the rear, the cutout 52 is closed by the third layer 22, in the shown embodiment by the third substrate 42, more precisely the third ground plane 44 on the front surface of the third substrate 42. Of course, this is valid except for the region of the slot 48.

Horizontally, i.e. in the longitudinal direction L and the transverse direction T, the cutout 52 is fully encompassed by the sheet metal of the second layer 20.

Thus, a cavity 54 is provided by the cutout 52 enclosed by the layers 18, 20, 22. Further, the first layer 18, the second layer 20 and the third layer 22, more precisely the first ground plane 40 of the first layer 18, the sheet metal of the second layer 20 and the ground plane 44 on the front surface of the third substrate 42 shield the cavity 54 electrically.

The delay lines 26 are located at the front surface of the third substrate 42, and may be provided as a metallization applied to the front surface of the third substrate 42. The delay line 26 may be covered by the insulating material 50.

The third ground plane 44 on the rear surface of the third substrate 42 covers the delay line 26 vertically and forms a microstrip transmission line together with the delay line 26.

The delay lines 26 may be regarded as part of the third layer 22.

As such, the delay lines 26 are located at the rear of the cavity 54, in other words within a vertical projection P of the cavity 54 rearwards.

It is also conceivable, that the delay lines 26 are located within the cavity 54 or as part of the first layer 18 on the side facing the second layer 20.

Within the cavity 54, the shifting portion 32 of the shifting device 28 is located.

As can be seen in FIG. 4, with respect to the transverse direction T, the shifting portions 32 have a middle section 56 and two outer sections 58. The middle section 56 is located between the outer section 58 in the transverse direction T.

The middle section 56 is located at the front of the respective delay line 26 and the outer sections 58 are located transversally to the delay lines 26.

The outer sections 58 have at their rear end, i.e. their end facing the third layer 22, a curved contour. In particular, the outer sections 58 have a circular contour.

The rear end of the middle section 56 is flat and offset to the rear end of the outer sections 58 to the front. Thus, the rear end of the outer sections 58 extends further to the rear than the rear end of the middle section 56.

Due to the offset, the outer sections 58 are physically in contact with the insulating material 50 or with the third layer 22, wherein the middle section 56 is vertically spaced apart from the insulating material 50, the delay lines 26 and/or the third layer 22. By means of this arrangement, the friction between the cavity walls and the shifting portions can be reduced.

Further, the shifting portions 32, in particular the middle sections 56 may comprise cutouts (see FIG. 2), for example so-called transformation windows. FIG. 5 shows a cross-section similar to that of FIG. 4 at the location of the slot 48.

As can be seen, the slot 48 extends vertically rearwards from the cavity 54.

The actuation portion 34 of the shifting portion 32 extends from the shifting portion 32 in the cavity 54 vertically through the slot 48 to the rear side of the third layer 22.

As indicated in dashed lines, the actuating mechanism 30 is located at the rear side of the third layer 22 and is mechanically connected to the actuation portion 34 of the shifting device 28.

The actuating mechanism 30 comprises an actuator 60, a gearing 62 and a driving structure 64.

In the shown embodiment, the driving structure 64 may be plate-shaped and thus be a driving plate.

The driving structure 64 extends parallel to the rear surface of the third substrate 42, and the actuation portion 34 is attached to the driving structure 64 at its rear end, for example by screws.

The actuator 60 may be an electric motor and it is mechanically connected to the driving structure 64 by the gearing 62 in a way that the actuator 60 is able to move the driving structure 64 linearly in the direction of motion M.

Further, the actuating mechanisms 30 of the phase shifters 16 may be combined to reduce the space needed, albeit on the rear side of the third layer 22.

In the shown embodiment, a single driving structure 64 and a single actuator 60 with a single gearing 62 are provided for all of the phase shifters 16. As such, the driving structure 64 is attached to the actuation portions 34 of all of the phase shifters 16 to the effect that the shifting devices 28 may be actuated in unison.

It is also conceivable that each phase shifter 16 comprises its own actuating mechanism 30 or that only two, three or more phase shifters 16 are actuated by the same actuating mechanism 30.

Thus, by means of the actuator 60 and the driving structure 64, the actuation portion 34 and thus the entire shifting device 28 is actuated back-and-forth in the direction of motion M.

The length of the part of the delay line 26 covered by the respective shifting portion 32 varies depending on the position of the shifting device 28.

Radio frequency signals fed to the delay lines 26 propagate along the respective delay line 26 and then via the distribution lines 38 on the front to the respective radiator 12.

The time the signals need to pass the delay lines 26 depends on the length of the delay line 26 covered by the shifting device 28, as the dielectric material of the shifting portion 32 changes the transmission properties compared to portions without the shifting portion 32 present.

Thus, a phase shift can be induced and changed by the movement of the shifting device 28 in the direction of motion M.

Further, as the cavity 54 is almost entirely electrically shielded, the concentration of the electrical field in the cavity 54 is high so that the phase shifting effect of the shifting portion 32 is increased. Thus, a high quality phase shifter 16 is achieved cost efficiently by common manufacturing techniques for manufacturing PCB and sheet metal layers.

Further, due to the three layers 18, 20, 22, the phase shifter 16 is highly integrated into the antenna 10, requiring less space.

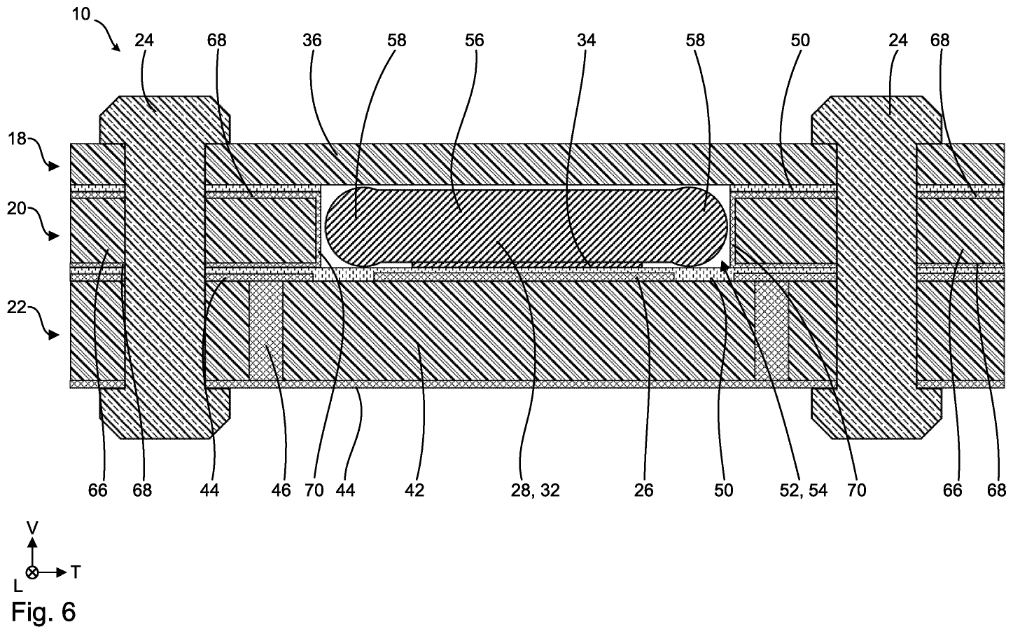

FIGS. 6 to 9 show further embodiments of the antenna 10 according to the invention that substantially corresponds to the antenna 10 discussed above. Thus, in the following, only the differences are discussed and the same and functionally the same components are labeled with the same reference signs.

FIG. 6 shows a second embodiment of an antenna 10 according to the invention in a view corresponding to that of FIG. 4.

In difference to the first embodiment, in the second embodiment, the second layer 20 comprises a second substrate 66, in particular a PCB.

The second substrate 66 has second ground planes 68 located at the front surface and the rear surface of the second substrate 66. The second ground planes 68 are grounded.

Further, a conductive wall 70 of the second layer 20 are located at the faces of the second substrate 66 facing and bordering the cavity 54. The conductive walls 70 encompass the cutout 52 entirely along its periphery.

The conductive walls 70 are grounded and may be provided as metallizations applied to the faces, and are in particular galvanically connected to each other and to both of the second ground planes 68.

The conductive walls 70 provide the electric shielding for the cavity 54 in this embodiment.

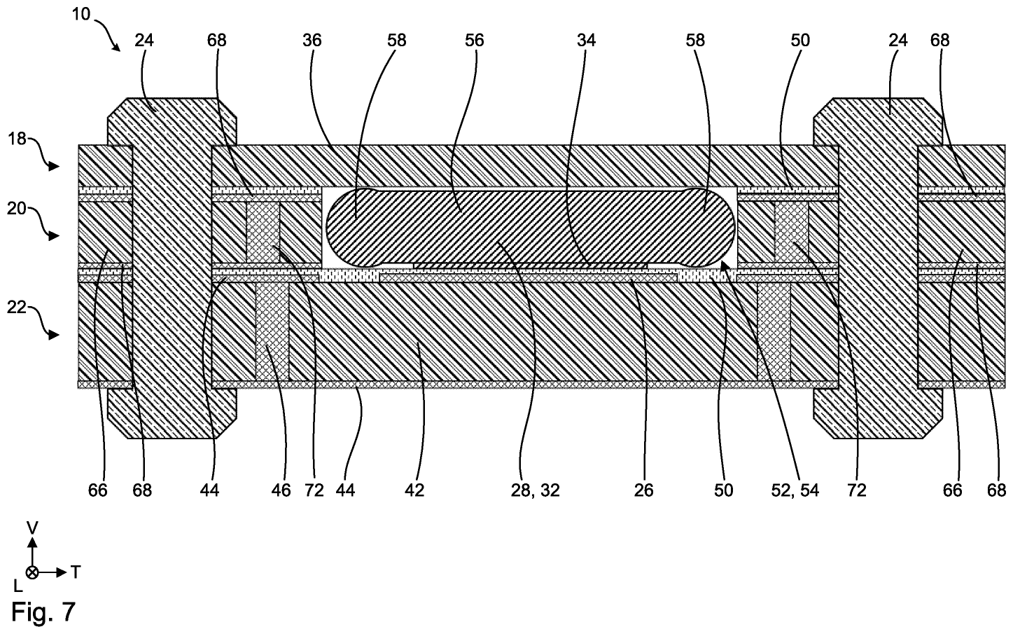

FIG. 7 shows a third embodiment of an antenna 10 according to the invention in a sectional view corresponding to that of FIGS. 4 and 6.

The third embodiment corresponds to the second embodiment, wherein second vias 72 are extending through the second substrate 66 galvanically connecting the two second ground plane 68.

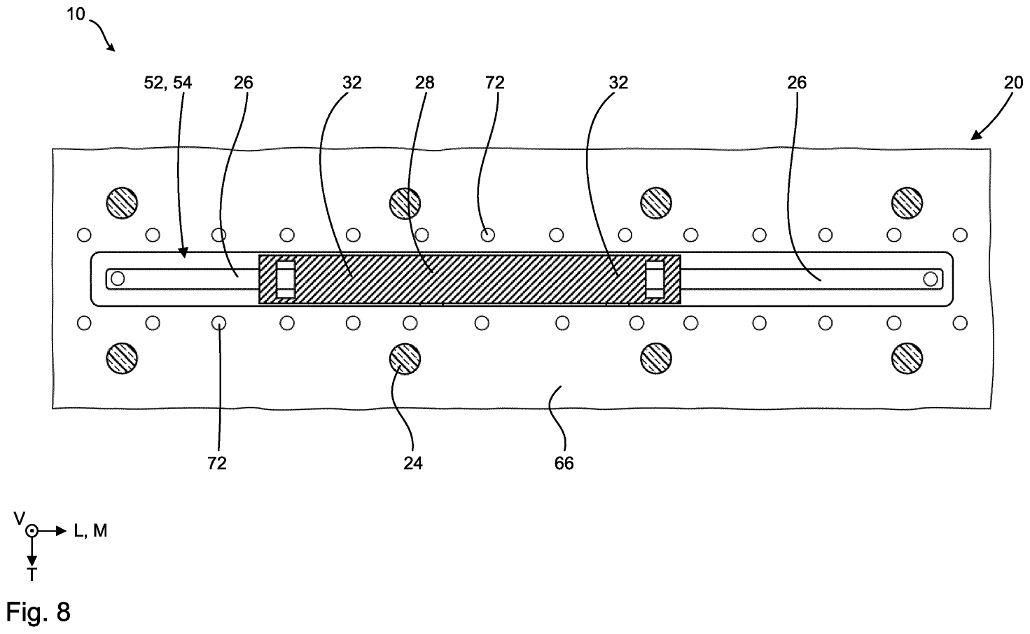

FIG. 8 shows a view in the vertical direction on a horizontal section through the second substrate 66.

It can be seen, that the vias 72 are arranged around the full periphery of the cutout 52. The vias 72 are spaced apart by a distance smaller or equal to one eighth of the wavelength of the average frequency of the design frequency range of the radiators 12. This way, the grounded vias 72 provide the electric shielding of the cavity 54 horizontally. Thus, the walls 70 are not provided in the shown third embodiment.

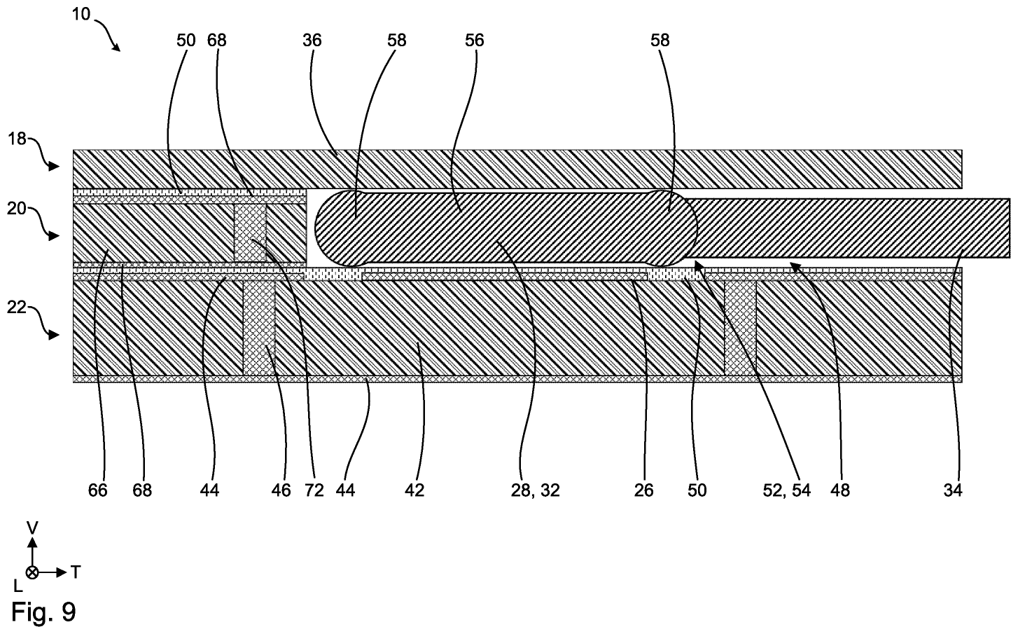

FIG. 9 shows a fourth embodiment of an antenna 10 according to the invention in a sectional view similar to that of FIG. 5.

In the fourth embodiment, the second layer 20 is provided as discussed with respect to the third embodiment. The second layer 20 may as well be provided as in the second embodiment or the first embodiment.

In difference to the first embodiment, the slot 48 is not provided in the third substrate 42 but in the second layer 20, i.e. in the sheet metal or, as shown in FIG. 7, in the second substrate 66.

The slot 48 extends from the cavity 54 in the transverse direction T and thus the actuation portion 34 of the shifting device 28 also extends the transverse direction T through the slot 48.

In this case, the actuating mechanism 30 may be arranged besides the layers 18 to 22.

1. An antenna, in particular for a mobile communication cell site, comprising a plurality of radiators, a reflector for the radiators, a first layer, a second layer, a third layer, and at least one phase shifter with at least one delay line and a shifting;
wherein the first layer, the second layer and the third layer extend parallel to one another, the second layer being located between the first layer and the third layer;
wherein the radiators are mounted at the front side of the first layer the first layer, and the reflector for the radiators is provided by the first layer, the second layer, and/or the third layer;
wherein the second layer comprises a cutout extending vertically through the second layer, the cutout being closed to the front by the first layer and to the rear by the third layer forming a cavity;
wherein the delay line is arranged within a vertical projection of the cavity; and
wherein the shifting device comprises an actuation portion and a shifting portion, the shifting portion being arranged in the cavity covering the delay line at least partly and being movably with respect to the delay line in a direction of motion.

2. The antenna according to claim 1, wherein the delay line is located in the cavity, at the first layer on the side of the first layer facing the cavity, or at the third layer on the side of the third layer facing the cavity

3. The antenna according to claim 1, wherein the first layer, the second layer, and the third layer electrically shield the cavity.

4. The antenna according to claim 1, wherein the first layer comprises a first substrate, the third layer comprises a third substrate, and/or the second layer comprises a second substrate or a metal sheet.

5. The antenna according to claim 1, wherein insulating material, in particular a solder stop mask, is provided between the first layer and the second layer and/or between the second layer and the third layer.

6. The antenna according to claim 1, wherein the first layer comprises a first substrate and distribution lines on the front surface of the first substrate, the distribution lines being connected to the radiators.

7. The antenna according to claim 1, wherein the first layer comprises a first ground plane, in particular on the rear surface of the first substrate, wherein the first ground plane providing the reflector for the radiators and/or covering the cutout of the second layer vertically.

8. The antenna according to claim 1, wherein the at least one delay line is located at the third layer, in particular wherein the third layer comprises a third substrate and the delay line is located on the front side of the third.

9. The antenna according to claim 1, wherein the third layer comprises a third ground plane, in particular at the rear surface of the third substrate, the third ground plane covering the cutout of the second layer and/or the delay line vertically.

10. The antenna according to claim 1, wherein a slot is provided, the slot extending in the third layer, in particular in the third substrate, in the direction of motion as well as from the cavity vertically rearwards through the third layer, or the slot extending in the second layer, in particular in the second substrate or the metal sheet, from the cavity transversally, wherein the actuation portion of the shifting device extends from the shifting portion through the slot.

11. The antenna according to claim 1, wherein the second layer comprises a second substrate, in particular a PCB, wherein the faces of the second substrate defining the cutout are provided with a grounded conductive wall, in particular a metallization, and/or wherein a plurality of grounded vias are provided in the second substrate, the plurality of vias being arranged around the cutout with a distance between adjacent vias smaller or equal than one eighth of the wavelength of the average frequency of the design frequency range of the radiators.

12. The antenna according to claim 1, wherein, with respect to the transverse direction, the shifting portion comprises a middle section and two outer sections, wherein the outer sections have a rear end extending further to the rear than the middle section in particular wherein the rear ends of the outer sections have a curved contour.

13. The antenna according to claim 12, wherein the middle section is located in front of the delay line and/or the outer sections contact the third layer or an insulating material transversally besides the delay lines.

14. The antenna according to claim 1, wherein the antenna comprises an actuating mechanism, in particular located at the rear side of the third layer, wherein the actuating mechanism is mechanically connected to the actuation portion of the shifting device and designed such that it is able to move the shifting device in the direction of motion.

15. The antenna according to claim 14, wherein the actuating mechanism comprises an actuator, in particular an electric motor, and a driving structure movable linearly in the direction of motion by the actuator, wherein the driving structure is attached to the actuation portion of the shifting device.

16. The antenna according to a claim 1, wherein the shifting portion is made of a dielectric material and/or comprises cutouts.

17. The antenna according to claim 1, wherein the delay line is located next to the slot with respect to the direction of motion.

18. The antenna according to claim 1, wherein at least two delay lines are provided in the vertical projection of the cavity and the shifting device comprises two shifting portions, wherein the slot is located between the two delay lines with respect to the direction of motion.

19. The antenna according to claim 1, wherein the antenna comprises a plurality of cavities and a plurality of phase shifters, wherein the radiators are arranged in columns parallel to the direction of motion, in particular wherein the cavities and shifting portions are located between the radiators of adjacent columns.

20. The antenna according to claim 1, wherein the antenna comprises a plurality of cavities and a plurality of phase shifters, wherein the actuation portions of two, more than two or all of the shifting devices is attached to a single driving structure, in particular at the rear side of the third layer, the driving structure being movable linearly in the direction of motion by an actuator
